(19) United States
(12) Patent Application Publication
(10) Pub. No.: US 2012/0198256 A1
(43) Pub. Date: Aug. 2, 2012

(54) Method for Setting the Clock Frequency of a Microprocessor of an Industrial Automation Component, and Automation Component Having a Microprocessor with a Variable Clock Frequency

(75) Inventor: Günter Neumann, Heroldsbach (DE)

(73) Assignee: Siemens Aktiengesellschaft, Muenchen (DE)

(21) Appl. No.: 13/362,313

(22) Filed: Jan. 31, 2012

(30) Foreign Application Priority Data
Jan. 31, 2011 (EP) EP11152705

(51) Int. Cl. G06F 1/00

(52) U.S. Cl. 713/322

(57) ABSTRACT

Method and an automation component for setting the clock frequency of a microprocessor in an industrial automation arrangement, the clock frequency of the microprocessor being selected depending on a required computation power, wherein in a first step, the required duration for execution of the main program cycle of a control program running on the automation component is detected, in a second step, this duration is compared with a maximum value, and in a third step, a new clock frequency is determined depending on the result of the comparison and used for the microprocessor. The method and automation component make it possible to match the clock frequency of the microprocessor dynamically, wherein firstly, the required computation power is always provided, and secondly an unnecessarily high clock frequency is avoided. As a result, a corresponding saving on energy and reduction in the power losses can be achieved.

### BACKGROUND OF THE INVENTION

1. Field of the Invention

The invention relates industrial automation and, more particularly, to a method for setting the clock frequency of a microprocessor of an industrial automation component, and the automation component.

2. Description of the Related Art

In industrial automation arrangements, a large number of automation components are usually operated, these automation components often being referred to as programmable logic controllers (PLCs) or “CPUs” or the like, where the components are often microprocessor-controlled computation units that control a manufacturing process or another automation task via sensors and actuators, IOs for short. In conventional automation arrangements, a large number of automation components, which are controlled by a microprocessor in this way, are usually used. As a result, the energy requirement of these automation components, i.e., the controllers, constitutes a significant proportion of the total energy requirement of an automation arrangement. In order to decrease the consumption of electrical power of an automation arrangement as far as possible, not only motors, heaters, lighting devices or the like are therefore taken into consideration or optimized, but it is also necessary for the energy requirement of the controllers, i.e., the microprocessor-controlled automation components, to be reduced as far as possible.

It is therefore conventional, for example, to disconnect the controllers and therefore automation components that are not required during breaks in operation or in the case of temporarily unused system parts. Here, the states “rest state” or “standby mode” known from the sector of personal computers are also used increasingly for automation components, i.e., either a microprocessor is disconnected or only one main memory is now supplied with energy (standby mode), or a main memory content is temporarily backed up on a hard drive or the like, whereupon the microprocessor and the entire motherboard are likewise brought out of operation (rest state). For reasons of availability, these methods cannot be used in anywhere near all automation arrangements, however.

The power consumption (i.e., energy requirement) of a microprocessor can be assumed in a first approximation as being proportional to the clock frequency at which the microprocessor is operated (system clock). It is therefore known in the case of personal computers, i.e., in the case of (rechargeable) battery-operated appliances (for example, laptops), to select the clock frequency of the microprocessor depending on the required computation power, where the clock frequency is reduced in the idle state, while the clock frequency is increased during processing of complex tasks. As a result, the power consumption and the power losses are increased further. In the described personal computers, this functionality is provided by the chip manufacturers and is controlled by the respective operating system. However, it is disadvantageous that, when particularly transferring from a low clock frequency to a relatively high clock frequency, delays can occur which, although often accepted in the case of personal computers, are not tolerable in industrial automation arrangements in which “real-time operation” is often required. Moreover, the operating systems and in particular the application programs of programmable logic controllers and other automation components are often configured such that an idle state does not occur. The reason for this is that after execution (as quickly as possible) of a cycle, the next cycle is started without a delay. Consequently, an idle state does not occur. Even in cases in which the next cycle is started with a delay, it is not possible and intended or possible to temporarily reduce the clock frequency (system clock) without running the risk of faults and delays.

### SUMMARY OF THE INVENTION

It is therefore an object of the present invention to provide a method and an automation component, whereby the energy consumption of a microprocessor-controlled automation component can be reduced taking into consideration the respectively required functionality.

This and other objects and advantages are achieved in accordance with the invention in which taking into account a central concept of a solution to the problem of determining the degree of capacity utilization of an automation component, and by then establishing the required computation power and thus determining the optimum value, from the point of view of energy savings and from the point of view of the required functionality, for the clock frequency of the microprocessor and applying this to the microprocessor. In accordance with the invention, the runtime (i.e., the duration) of the main program cycle is detected as a measure for the required computation power and therefore for the required clock frequency of the microprocessor of the programmable logic controller or the automation component and is used as a parameter for the determination of the clock frequency. The main program cycle is often also referred to as the “main loop”, “background task” or in the context of Simatic controllers as “OB1” (first organization block). In the main program cycle, the essential program sections for controlling an application and therefore an industrial automation arrangement are conventionally executed. As a result, the basic regulation cycle of a controller is established with this runtime or repetition frequency and, therefore, the runtime represents a measure for the slowest response time of an arrangement. The main program cycle is interrupted by higher-priority execution levels, in which fast regulation tasks, movement controllers, process reactions or the like are simulated. A higher computation power requirement in the higher-priority execution levels therefore automatically extends the runtime (i.e., the cycle time) of the main program cycle. Therefore, the runtime of the main program cycle is a measure of the total present computation power requirement of an automation component. In rest phases, the computation load automatically decreases since many event-controlled calculations are cancelled, such as periphery alarms, calculation of movement profiles in the movement controller or interruptions. A user can intensify these effects if his program skips all unrequired functions in the rest state of a machine. In short, the required (maximum) runtime (cycle duration) of the main program cycle is a good measure of the required computation power and predetermines the required clock frequency of the microprocessor used.

The object of the invention is achieved by a method for setting the clock frequency of a microprocessor of an industrial automation component. In accordance with the method of the invention, the clock frequency of the microprocessor is selected depending on the required computation power, wherein in a first step, the duration required at that time for execution of the main program cycle of a control program running on the automation component is detected. In a second step, this duration is compared with a predetermined maximum value. In a third step, the new clock frequency is determined depending on the result of the comparison and used for the microprocessor. By virtue of such cyclic or permanent monitoring of the runtime (execution duration) of the main program cycle, it is also always possible to select the clock frequency of the microprocessor in the case of a fluctuating demand for computation power such that the clock frequency is not unnecessarily high but is also quick enough to ensure that the main program cycle is executed within a required maximum time.

The object of the invention is also achieved by an automation component for controlling an industrial automation arrangement equipped with a microprocessor with a variable clock frequency, where the automation component is configured to set the clock frequency of the microprocessor using the abovementioned method.

Advantageously, a filtered value for the duration that is formed from a plurality of detected durations of proceeding runs of the main program cycle is used for the comparison in the second step of the method. Thus, undesired oscillation of the clock frequency is avoided, particularly in the case of short-term fluctuations in the runtime. This has proven to be particularly advantageous when, in addition to the filtering of the parameter “runtime”, for example, by averaging or low-pass filtering, the matching of the clock frequency is performed using a hysteresis, where the clock frequency is only changed when, using the comparison, a new clock frequency is determined that is outside the hysteresis for the previously valid clock frequency. This is particularly advantageous if the clock frequency is not continuously adjustable, but is adjustable in a stepwise manner. It thus becomes possible to establish a value of pairs (lower switching threshold, upper switching threshold) for the switching hysteresis for each switching step of the clock frequency. Particularly in time-critical processes, it may be expedient for the next highest switching step, measured against the determined (required) clock frequencies, to always be provided for the clock frequency, where advantageously also a “safety range”, such as 10%, can be added on to the determined required clock frequency. In order to increase the operational reliability, i.e., in the case of real-time requirements, the values for the switching thresholds can be arranged asymmetrically about the steady-state value for the clock frequency step.

In cases in which the value for the runtime of the main program cycle is filtered, such as by low-pass filtering, it is advantageous if, once the clock frequency or clock frequency step has been changed, the “start value” of the filter algorithm is set to that value which is expected, using the newly set clock frequency, for the future runtime of the main program cycle; this applies in particular in the case of averaging in the filter.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method according to the invention will be explained below with reference to the drawings. The exemplary embodiment serves at the same time to explain an automation component according to the invention, in which:

FIG. 1 is a schematic block diagram of a method for setting the clock frequency of a microprocessor in accordance with the invention;

FIG. 2 is a graphical plot of a switching characteristic for a switchover of the clock frequency or clock frequency step in accordance with the invention;

FIG. 3 is a graphical plot of a hysteresis resulting during setting a clock frequency of a microprocessor in accordance with the invention; and

FIG. 4 is a flow chart of the method in accordance with an embodiment of the invention.

### DETAILED DESCRIPTION OF THE PRESENTLY EMBODIMENTS

In the text which follows, it is assumed that a user has knowledge of how long the maximum runtime of a main program cycle should be in order to be able to control or regulate an automation to be controlled or a process to be controlled/regulated sufficiently quickly. This duration is referred to below and in the figures as process duration PD. If the runtime LZ (cycle time) formed therefrom is markedly below this maximum value, however, this is an indication that a process is in a rest phase or at least the clock frequency is set unnecessarily high in relation to the required computation power. In this case, the clock frequency (system clock, process clock) of the microprocessor CPU can be reduced as long as the runtime LZ or the process duration PD remains below the maximum value. As the computation load increases, however, the runtime LZ increases again, where the clock frequency then needs to be re-increased at the latest when the maximum time is exceeded.

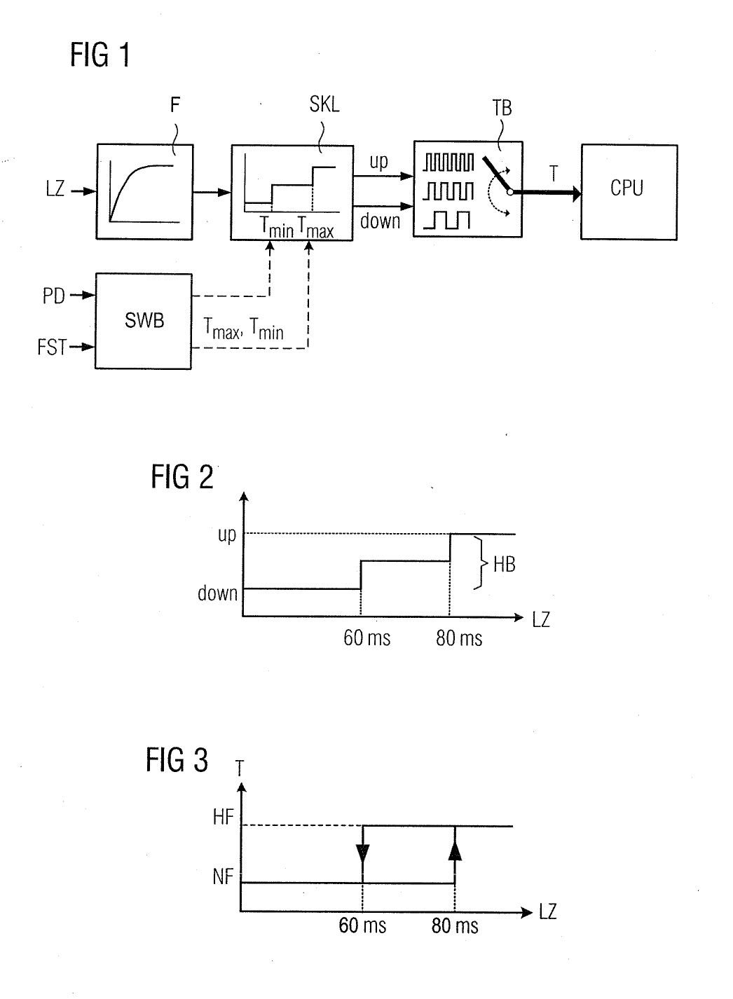

FIG. 1 shows a schematic block diagram that will be used in the following text to explain the setting of a clock frequency T for the microprocessor CPU of an industrial automation component.

In principle, the block diagram in FIG. 1 represents a digital regulating controller, whose input variables, in this simplified illustration, represent the present runtime LZ of a main program cycle of a program that is running on the microprocessor CPU, where furthermore a (maximum permissible) process duration PD is predetermined as the maximum value and ultimately possible frequency steps FST are introduced into the calculation, with these frequency steps FST generally being predetermined by the hardware used, i.e., conventional main system printed circuit boards (mother boards) often only permit stepwise matching of a clock frequency.

The method for determining/setting the clock frequency using modules/function modules in accordance with the invention will be described in the text which follows. It should be noted that these operations can be calculated within a single function module or in a differently organized software or the like, however. Advantageously, these calculations are performed by a function in an operating system of the automation component. In particular, a measurement of the runtime of the main program cycle is also performed by such an operating system. Conventionally, a main program cycle is in any case always started by the operating system and the end of the main program cycle is monitored or registered. As a result, the method described below can be implemented without the application program of an automation component needing to be changed.

In a function block for switching value determination SWB, limit values Tₘᵢₙ, Tₘₐₓ are determined from the predetermined (maximum) process duration PD and from the predetermined frequency steps FST, and are transmitted to a block for determining the switching characteristic SKL. This switching characteristic, i.e., switching hysteresis, is illustrated in further detail in FIG. 2. A further input signal for the block for establishing the switching characteristic SKL is the “signal” filtered by a filter device F, i.e., a filtered value for the runtime LZ. The block for filtering F in the process performs averaging or low-pass filtering. Naturally, more complex filter algorithms, depending on the application purposes, are also conceivable. Output signals of the block for calculating the switching characteristic SKL are commands “up”, “down” for increasing or reducing the clock frequency or clock rate T, where, using the previously mentioned available switching steps for the clock frequency in the block clock frequency determination TB, the next highest or next lowest step for the clock frequency T is selected, depending on the command, and where the correspondingly selected clock frequency T is then applied to the microprocessor CPU.

FIG. 2 is a more detailed graphical plot of the switching characteristic SKL used in the block for the calculation or determination of the clock frequency T. This switching characteristic SKL is produced based on the predetermined process duration PD or the maximum runtime Tₘₐₓ calculated therefrom and, in an advantageous configuration, varies with the clock frequency step used. Here, the maximum value Tₘₐₓ in most cases does not represent an absolute upper limit which, when exceeded, could possibly have fatal effects on a process to be controlled. Sporadic instances of the upper limit being slightly exceeded are in most cases not unusual, depending on a requirement profile, and can often be tolerated. The determined maximum time Tₘₐₓ in these cases corresponds to the mean runtime LZ of the main program cycle that can be determined, for example, by the filter F and which can be set in the “worst case” operating mode, such as under full load. If required, in particular during control of time-critical processes, the maximum value Tₘₐₓ used can also be a value that is below the maximum process duration PD specified by a user, for example, 90% of the limit specified by the user. As soon as the runtime LZ, possibly as a filtered value, falls below the limit Tₘᵢₙ (in FIG. 2 this is 60 ms), the clock frequency of the microprocessor CPU can be reduced (“down”). Conversely, the switching command “up” is issued in the case of an excessively long runtime LZ. Here, the value for Tₘᵢₙ is dependent on the next lowest clock frequency T that can be set for the microprocessor CPU, i.e., can vary from switching step to switching step. Here, Tₘᵢₙ is selected such that, after a clock reduction with the computation requirement unchanged, such as a new runtime (cycle time) LZ, is produced that is between Tₘᵢₙ (in this case: 60 ms) and Tₘₐₓ (in this case: 80 ms). If appropriate. Therefore, a plurality of clock frequency steps need to be skipped in the event of a change, or the method needs to be applied a plurality of times in succession. As long as the runtime LZ is between the minimum value and the maximum value, the switching characteristic remains in the hysteresis range HB. As a result, in this range, no change in the clock frequency T or the clock frequency step that is used is initiated.

FIG. 3 is a graphical plot of a controller response for the clock frequency T resulting from the switching characteristic SKL with the hysteresis range HB shown in FIG. 2. Corresponding to the switching characteristic SKL, runtimes LZ of less than (or equal to) 60 ms result in a lower clock frequency T (NF), while runtimes LZ of greater than (or equal to) 80 ms result in a higher clock frequency T (HF). The switching hysteresis illustrated in FIG. 2 therefore results directly in a clock frequency hysteresis. As a result of a suitably established hysteresis, undesired oscillation of the clock frequency T is avoided.

Since, owing to a switchover of the clock frequency for the filtered value for the runtime LZ, first a new, steady-state value for the runtime LZ (filtered) would be produced with a delay, there should be no reliance on the previous filtered runtime value LZ after switchover as well. In order for the filtered value to “settle” as quickly as possible, in this case the abovementioned measure is taken, which includes “pre-placing” the filtered value at the value expected on the basis of the new clock frequency.

Particularly in the case of large, complex automation arrangements, in an alternative embodiment it may be expedient not to predetermine a fixed value for the maximum process duration PD or the maximum runtime Tₘₐₓ, but to generate this value dynamically by other components and to transmit this value by a data telegram (“PROFI energy telegram”), for example. As a result, a superordinate system management can, for example, switch the automation component in a targeted manner into a state with a lower energy consumption or with a higher performance.

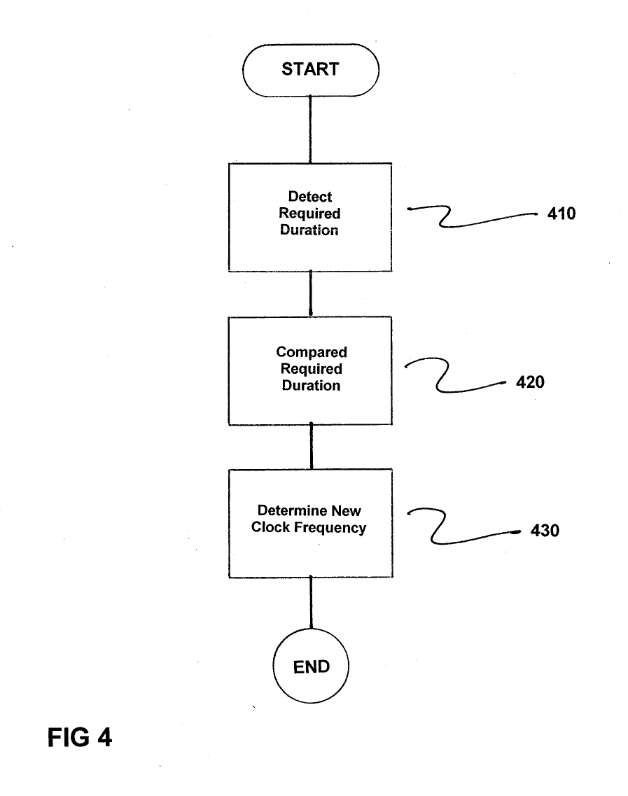

FIG. 4 is a flow chart of a method for setting the clock frequency of the microprocessor (CPU) of an industrial automation component, where the clock frequency of the microprocessor is selected depending on the required computation power. The method comprises detecting a required duration for execution of a main program cycle of a control program executing on the automation component, as indicated in step 410. The required duration is compared with a maximum value, as indicated in step 420. Next, a new clock frequency is determined depending on a result of the comparison and selecting the new clock frequency for the microprocessor, as indicated in step 430.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for setting a clock frequency of a microprocessor (CPU) of an industrial automation component, the clock frequency of the microprocessor being selected depending on a required computation power, the method comprising:
detecting a required duration for execution of a main program cycle of a control program executing on the automation component;
comparing the required duration with a maximum value; and
determining a new clock frequency depending on a result of the comparison and selecting the new clock frequency for the microprocessor.

2. The method as claimed in claim 1, wherein the required duration used for the comparison is formed from a plurality of detected durations for a plurality of runs of the main program cycle.

3. The method as claimed in claim 1, further comprising:
establishing clock frequency steps for the clock frequency;
wherein, during the step of determining the new clock frequency, the new clock frequency selected for the microprocessor is a next highest clock frequency step in relation thereto.

4. The method as claimed in claim 1, further comprising:
setting the clock frequency using a hysteresis;
wherein the clock frequency is varied in cases in which, based on the comparison, the new clock frequency is determined which is outside the hysteresis for a previously valid clock frequency.

5. The method as claimed in claim 1, wherein the determined value for the new clock frequency is filtered prior to use.

6. The method as claimed in claim 5, wherein, owing to the filtering of the determined clock frequency, any instances of the required duration exceeding the maximum value (PD) for at least one of a short period of time and slightly, do not influence the new clock frequency to be used in any way.

7. The method as claimed in claim 1, wherein the maximum value is predeterminable by one of a user or a further control device.

8. The method as claimed in claim 5, wherein, after matching the clock frequency, a filter is preset to a mean value for the required duration, the preset value being an estimated value for a future duration expected with a newly set clock frequency, the estimated value being calculated using the previous duration, a previous clock frequency and the newly set clock frequency.

9. An automation component for an industrial automation arrangement, comprising:
a microprocessor with a variable clock frequency;
wherein the automation component is configured to set a clock frequency of the microprocessor by:
detecting a required duration for execution of a main program cycle of a control program executing on the automation component;
comparing the required duration with a maximum value; and
determining a new clock frequency depending on a result of the comparison and selecting the new clock frequency for the microprocessor.
